(19) United States
(12) Patent Application Publication
(10) Pub. No.: US 2008/0226419 A1
(43) Pub. Date: Sep. 18, 2008

(54) FASTENING DEVICE AND METHOD OF FABRICATING THE SAME

(76) Inventors: JASON HOLT, St. Charles, IL (US); ALBERT W. VAN BOVEN, Barrington, IL (US); GLENN G. HEAVENS, Cheshire, CT (US)

Correspondence Address: ILLINOIS TOOL WORKS INC., 3600 WEST LAKE AVENUE, PATENT DEPARTMENT, GLENVIEW, IL, 60025, US

(21) Appl. No.: 12/034,369

(22) Filed: Feb. 20, 2008

Related U.S. Application Data
(60) Provisional application No. 60/906,978, filed on Mar. 14, 2007.

(51) Int. Cl. F16B 21/08; B21D 53/22; B23P 19/08

(52) U.S. Cl. 411/347; 470/3; 470/1; 470/2; 470/42

(57) ABSTRACT

A fastening device for coupling a first work-piece to a second work-piece. The fastening device includes a fastener body having a peripheral surface configured to be received in the first work-piece. The fastening device also includes a spring assembly coupled to the fastener body. The spring assembly includes a flange member, and a plurality of tunable springs extending radially outward from the flange member, the tunable springs are each configured to deform when a predetermined pressure is applied to the flange member, the predetermined pressure is sufficient to couple the first work-piece to the second work-piece.

### CROSS REFERENCE TO RELATED APPLICATION

This Non-Provisional Application claims benefit to U.S. Provisional Application Ser. No. 60/906,978 filed Mar. 14, 2007, the complete subject matter of which is expressly incorporated herein in its entirety.

### BACKGROUND OF THE INVENTION

The present invention relates generally to a fastening device, and more particularly to a fastening device that includes an integrated spring.

Fastening devices are used to couple a first work-piece in mounted relation to a second work-piece. In an assembly line application, components may be pre-assembled using one or more fastening devices to facilitate subsequent assembly thereof with other components. The assembly of rocker arm covers, or manifolds, to internal combustion engines in the automotive industry is representative of one such application among many others where pre-assembled work-pieces are employed with significant economic advantage.

One known method of coupling the first work-piece to the second work-piece includes using a non-isolated system. In a non-isolated system, the first work-piece is coupled directly to the second work-piece in a rigid or non-forgiving assembly. Another method of coupling the first work-piece to the second work-piece includes using an isolated system. In an isolated system, the first work-piece is decoupled from the second work-piece, such that noise, vibration, harshness, etc. generated by the second work-piece is not transferred to the first work-piece. One known isolated system utilizes a grommet installed between the first and second work-pieces to isolate the work-pieces.

For example, a pre-assembled valve cover may include one or grommets disposed in corresponding openings of the valve cover for subsequently fastening the valve cover to a head portion of an automotive engine. While isolated systems are preferable in many assembly applications, certain drawbacks exist. For example, isolated systems include an increased quantity of components in the assembly, e.g. grommets. Moreover, grommets may degrade or wear during use. As a result, the material costs of utilizing an isolated system increase due the increased costs of the component assemblies.

A need remains for a fastening device that provides the benefits of an isolated system, while also decreasing the quantity of parts and thus the cost to fabricate the isolated system.

### BRIEF DESCRIPTION OF THE INVENTION

In one embodiment, a fastening device is provided that includes a fastener body configured to be received in the first work-piece. The fastening device also includes a spring assembly coupled to the fastener body. The spring assembly includes a flange member, and a plurality of tunable springs extending radially outward from the flange member, the tunable springs are each configured to deform when a predetermined pressure is applied to the flange member, the predetermined pressure is sufficient to couple the first work-piece to the second work-piece. The plurality of tunable springs are spaced equidistantly around a periphery of the flange member. The plurality of tunable springs may be formed unitarily with the flange member.

In another embodiment, a method is provided for fabricating a fastening device for coupling a first work-piece to a second work-piece. The method includes determining a coupling force to be utilized to couple the first work-piece to the second work-piece, and fabricating a fastening device including a fastener body and a spring assembly coupled to the fastener body. The method further includes forming the spring assembly with a plurality of tunable springs that extend radially outward from the fastener body. The tunable springs are formed to deform when a predetermined pressure is applied to the fastening device. The predetermined pressure relates to the coupling force.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a partial sectional view of a pre-assembled work-piece and an exemplary fastening device in accordance with an embodiment of the invention.

FIG. 2 is a partial sectional view of the pre-assembled work-piece shown in FIG. 1 coupled to another work-piece using the exemplary fastening device in accordance with an embodiment of the invention.

FIG. 3 is a side view of an exemplary fastening device that may be used with the pre-assembled work-pieces shown in FIGS. 1 and 2 in accordance with an embodiment of the invention.

FIG. 4 is a top view of the fastening device shown in FIG. 3.

FIG. 5 is a perspective view of the fastening device shown in FIG. 3.

FIG. 6 is a flowchart illustrating an exemplary method for fabricating the fastening device shown in FIGS. 3-5.

FIG. 7 is a side view of another exemplary fastening device that may be used with the pre-assembled work-pieces shown in FIGS. 1 and 2 in accordance with an embodiment of the invention.

FIG. 8 is a top view of the fastening device shown in FIG. 7.

FIG. 9 is a perspective view of the fastening device shown in FIG. 7.

FIG. 10 is a side view of another exemplary fastening device that may be used with the pre-assembled work-pieces shown in FIGS. 1 and 2 in accordance with an embodiment of the invention.

FIG. 11 is a perspective view of the fastening device shown in FIG. 10.

FIG. 12 is a graphical illustration of a vibration transmission comparison between a known isolated system that includes a grommet and the exemplary fastening devices described herein in accordance with an embodiment of the invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE INVENTION

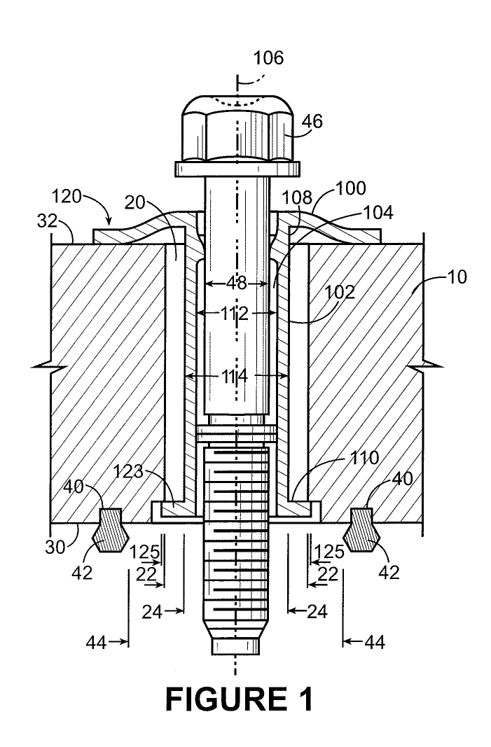

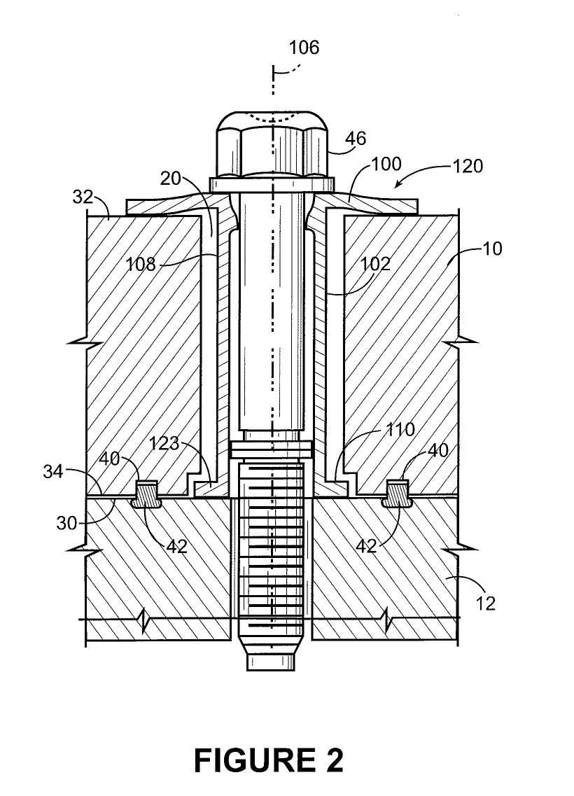

FIG. 1 is a partial sectional view of a pre-assembled work-piece 10 and an exemplary fastening device 100 in accordance with an embodiment of the invention. FIG. 2 is a partial sectional view of the pre-assembled work-piece 10 (shown in FIG. 1) that is coupled to another work-piece 12 using the exemplary fastening device 100 in accordance with an embodiment of the invention. In the exemplary embodiment, both the first and second work-pieces 10 and 12 are automotive assemblies such as a valve cover and an engine block. Optionally, fastening device 100 may be utilized to couple together any exemplary work-pieces.

The first work-piece 10 has an opening 20 extending there through that is sized to receive fastening device 100. The opening 20 has a diameter 22 that is greater than a diameter 24 of the fastening device 100 as will be discussed below. The first work-piece 10 has an inner surface 30 and an outer surface 32. As shown in FIG. 2, the inner surface 30 is disposed adjacent to a surface 34 of the second work-piece 12. In the exemplary embodiment, the first work-piece 10 may also include a groove or channel 40 formed therein that is sized to receive a gasket 42. In the exemplary embodiment, the channel 40 is substantially circular and has a diameter 44 that is greater than diameter 22 of opening 20. During assembly, the fastening device 100 is used to couple the first work-piece 10 to the second work-piece 12 using a fastener 46 to form a non-isolated system. In the exemplary device, the fastener 46 is a bolt having an outer diameter 48.

The exemplary fastening device 100 includes a fastener body 102 having an opening 104 extending there through. The fastener body 102 is configured to capture the fastener 46, and allow the fastener 46 to extend or retract through the fastener body 102. As such, the fastener body 102 is substantially tubular and has a centerline axis 106 extending axially there through. The fastener body 102 has a first end 108 and an opposite second end 110. The opening 104 has a diameter 112 that is greater than a diameter 48 of fastener 46 to enable the fastener 46 to be inserted at least partially through the opening 104. The fastener body 102 also has an outer diameter 114 that is less than the diameter 22 of opening 20 to enable the fastener body 102 to be inserted at least partially through opening 20.

The fastening device 100 further includes a radial spring assembly 120 that is coupled to the first end 108 of the fastener body 102 and a second radial flange 123 that is coupled to the second end 110 of the fastener body 102. In one embodiment, the second radial flange 123 has a diameter 125 that is less than the diameter 22 of opening 20 to enable the fastener body 102 to be inserted through the opening 20. In the exemplary embodiment, the diameter 125 of the second radial flange 123 is greater than the diameter 22 of opening 20 and the second radial flange 123 is fabricated from a flexible material to enable the fastener body 102 and the second radial flange 123 to be inserted into the opening 20.

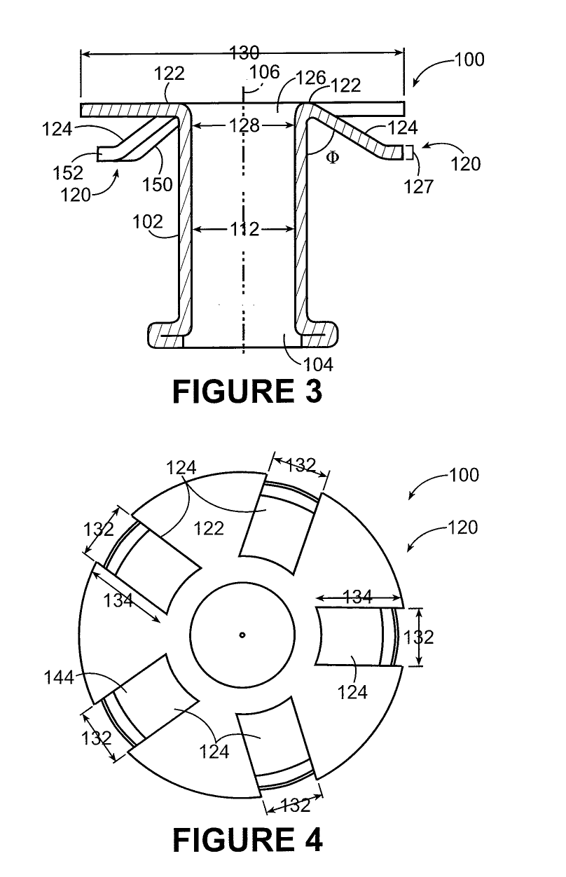

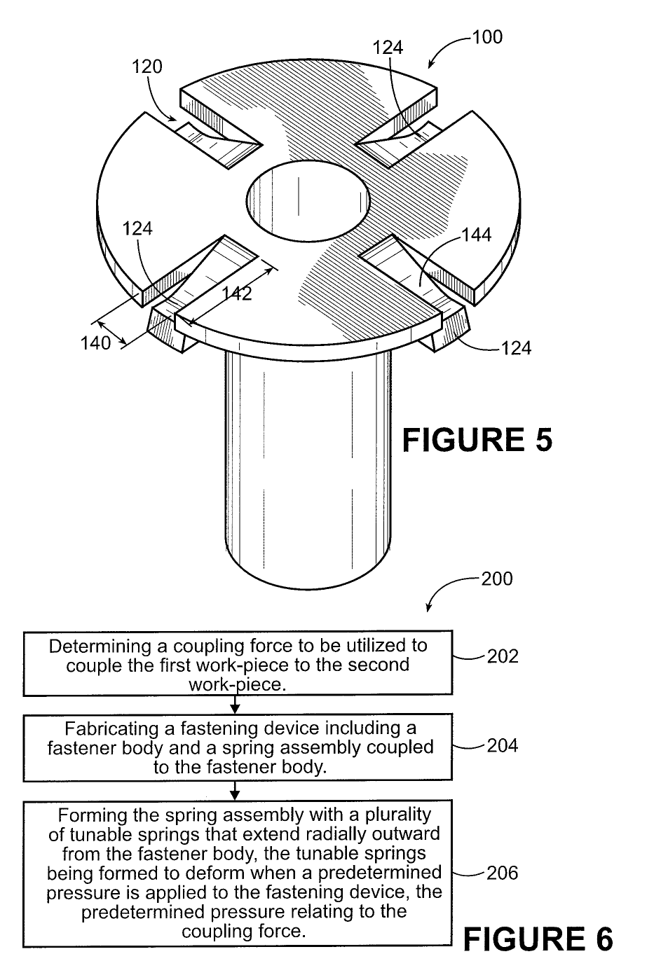

FIG. 3 is a side view of fastening device 100. FIG. 4 is a top view of fastening device 100. FIG. 5 is a perspective view of fastening device 100. As shown in FIGS. 3, 4, and 5. The spring assembly 120 includes a flange member 122 and at least one tunable spring 124. In the exemplary embodiment, the tunable spring 124 is a linear flex-spring of the cantilever type that extends radially outward from the flange member 122. During operation, the tunable spring 124 is configured to deform when a predetermined amount of pressure is applied to the flange member 122. The predetermined pressure is generally sufficient to couple the first work-piece 10 to the second work-piece 12. In the exemplary embodiment, the tunable spring 124 is formed unitarily with the flange member 122 and thus with fastener body 102. Optionally, the spring assembly 120 may be coupled to fastener body 102 using a welding or brazing procedure or a pressure crimp procedure.

In the exemplary embodiment, the flange member 122 is formed on the first end 108 of the fastener body 102 such that flange member 122 is approximately perpendicular to an outer periphery of fastener body 102. The flange member 122 has a substantially circular shape and includes an opening 126 extending there through. As such, opening 126 has a diameter 128 that is approximately equal to the diameter 112 of fastener body opening 104. Flange member 122 also has an outer diameter 130 that is greater than the diameter 112 of opening 104.

The spring assembly 120 may include one or more tunable spring arms 124. Each tunable spring arm 124 has a width 132 and a length 134. More specifically, the width 132 and length 134 of spring arm 124 is approximately equal to a respective width 140 and length 142 of a slot 144 formed in flange member 122. By way of example only, the spring arms 124 may be stamped and formed from the flange member 122 to form respective slots 144 in the flange member 122. In the exemplary embodiment, the spring arms 124 are spaced equidistantly around a periphery of the flange member 122. The width 132, length 134 and thickness of the spring arms 124 collectively form a portion of the dimensions that determine an amount of pressure that the spring assembly 120 is able to endure before deforming.

Each spring arm 124 includes a spring portion 150 having a first end that is coupled to, or formed unitarily with, the flange member 122. The spring arm also includes an integral contact portion 152 formed at a distal end of the spring portion. As shown in FIG. 3, the spring portion 150 is coupled to the flange member 122 and the contact portion 152 is configured to contact the second work-piece 12 as will be discussed below. The contact portion 152 is disposed approximately parallel to the flange member 122 and approximately perpendicular to the fastener body 102. Moreover, the spring portion 150 is disposed at an acute angle Φ with respect to the fastener body 102. The angle θ may also be measured relative to the centerline axis 106. In the exemplary embodiment, the angle Φ is less than 90 degrees and greater than 45 degrees.

In the exemplary embodiment, to fabricate fastening device 100, fastening device 100 is stamped from a single plate to form fastener body 102 and spring assembly 120. Optionally, spring assembly 120 is coupled to fastener body 102 using a welding or brazing procedure, for example. The spring assembly is stamped to form the flange member 122 and the plurality of spring arms 124. In the exemplary embodiment, each spring arm 124 is identical to each other respective spring arm 124 such that during fabrication, a single stamp may be utilized to manufacture multiple spring arms 124.

As discussed above, the spring arms 124 distributes the load applied by the bolt 46 onto a work-piece to allow the work-piece to move a designed amount to compensate for noise, vibration, or harshness purposes. As such, the spring arms 124 are tunable to fit any particular application and load curve desired. One such method of tuning the spring arms 124 is to fabricate the fastening device 100, including spring arms 124, from a selected material. The fastening device 100 may be fabricated from a particular metallic material to facilitate increasing the fastening device 100 ability to compensate for increased vibration or harsh conditions. For example, under some conditions, it may be desirable to fabricate the fastening device 100 using a stainless steel material. Under other operating conditions, it may be desirable to fabricate the fastening device using a copper or brass material for example. Under all conditions, the material for fastening device 100 is selected based on the various operational parameters, i.e. torque required, temperature, etc., to which the fastening device 100 is to be subjected.

Another exemplary method of tuning the fastening device 100 is to alter the quantity, size, or thickness of the spring arms 124. For example, to increase the stiffness and thus the load bearing capabilities of the spring arms 124, it may be desirable to increase a thickness 127 of the spring arms 124. To increase the surface area of the spring arms 124 contacting the work-piece 12, it may be desirable to increase the quantity of spring arms 124. Moreover, the length and/or width 132/134 of the spring arms 124 may be adjusted to allow for a decreased or increased torque to be transmitted from the bolt 46 to the second work-piece 12, i.e. to increase the pressure coupling the first and second work-pieces 10 and 12 together. For example, decreasing the length 134 and/or increasing the width 132 of a spring arm 124 increases the overall stiffness of the spring arm 124 which allows greater torque to be transmitted to the second work-piece 12. Whereas increasing the length 134 and/or decreasing the width 132 of the spring arm 124 results in a fastening device 100 which may be used to fasten work-piece 10 and work-piece 12 using less torque. Additionally, the fastener body 102 may function as a compression limiter allowing the fastener 46 to be adjusted to its proof load without crushing the fastener body 102.

During operation, the spring arms 124 maintain a predetermined torque on the fastener 46. Moreover, the spring arms 124 are flexible to enable the work pieces 10 and 12 to expand or contract while still maintaining the predetermined torque on the fastener 46 under variable operating conditions. The spring arms 124 also distribute the retention load of the fastening device 100 over an increased surface area of the first work-piece 10 thereby reducing any concentration of retention or coupling forces applied to the work-pieces.

FIG. 6 is a flowchart illustrating an exemplary method 200 for fabricating the fastening devices described herein. The method includes determining 202 a coupling force to be utilized to couple the first work-piece 10 to the second work-piece 12. The method 200 further includes fabricating 204 a fastening device 100 including a fastener body 102 and a spring assembly 120 coupled to the fastener body 102. The method further includes forming 206 the spring assembly 120 with a plurality of tunable springs 124 that extend radially outward from the fastener body 102, the tunable springs 124 being formed to deform when a predetermined pressure is applied to the fastening device, the predetermined pressure relating to the coupling force.

As discussed above, the tunable springs 124 are fabricated to deform at the predetermined pressure. To form an isolated system and thus reduce and/or eliminate the noise, vibration, or harshness between the first and second work-pieces 10 and 12, the spring arms 124 are configured to flex or deform when a desired amount of pressure is applied by the fastener 46. As such, when the desired amount of pressure is applied to fastening device 100, spring arms 124 are configured to deform at a pressure that is less than the pressure required to deform either work-piece 10 or work-piece 12.

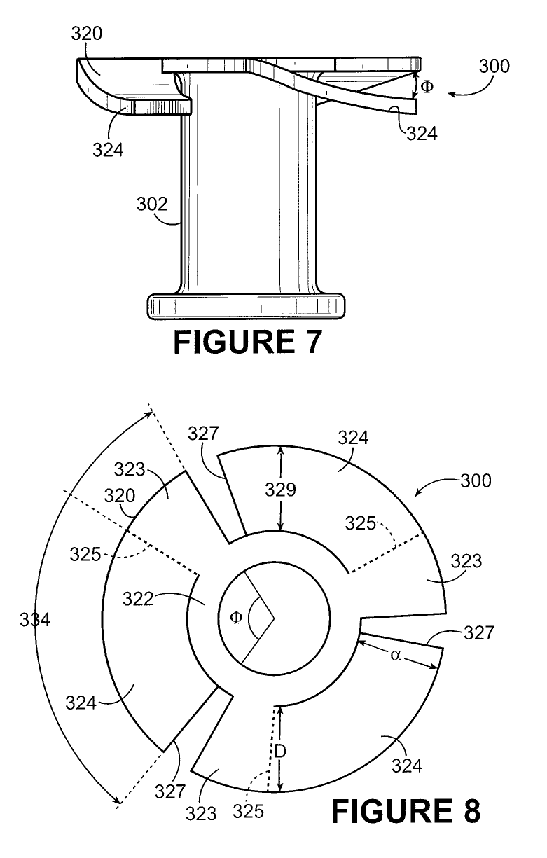

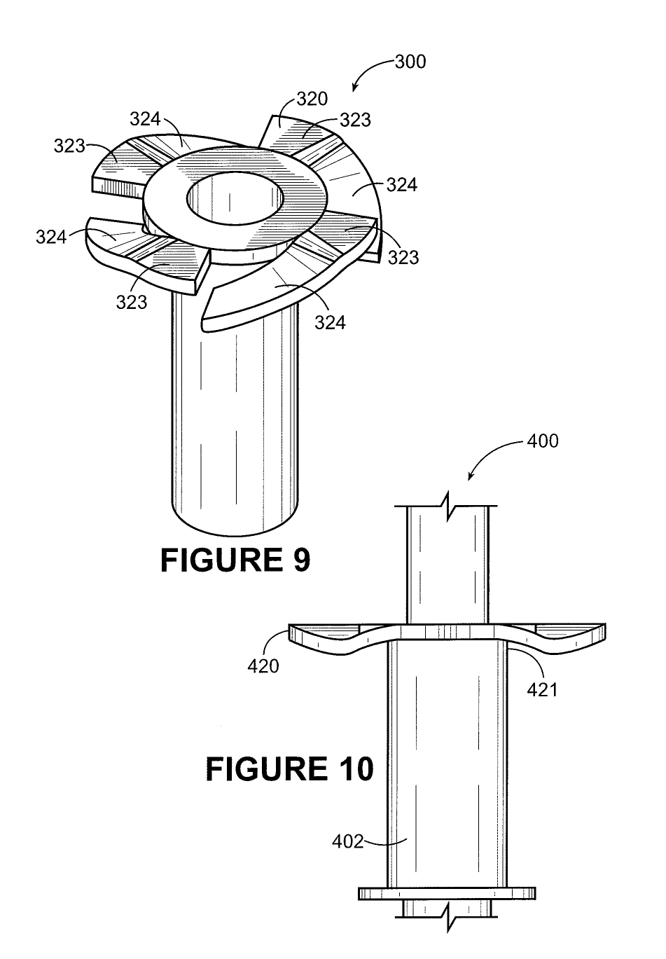

FIG. 7 is a side view of another exemplary fastening device 300 that may be used to couple work-piece 10 to work-piece 12. FIG. 8 is a top view of fastening device 300. FIG. 9 is a perspective view of fastening device 300. In the exemplary embodiment, fastening device 300 includes a spring assembly 320 that is coupled to a fastener body 302. The spring assembly 320 includes a flange member 322 and at least one tunable spring arm 324. In the exemplary embodiment, the tunable spring arm 324 is a linear flex-spring, of the cantilever type that extends axially around at least a portion of flange member 322 and/or fastener body 102.

In one exemplary embodiment, shown in FIG. 8, fastening device 300 includes three tunable spring arms 324. In another exemplary embodiment, shown in FIG. 9, fastening device 300 includes four tunable spring arms 324. During operation, the tunable spring arm 324 is configured to deform when a predetermined amount of pressure is applied to the flange member 322. The predetermined pressure is generally sufficient to couple the first work-piece 10 to the second work-piece 12. In the exemplary embodiment, the tunable spring arms 324 are formed unitarily with the flange member 322 and thus with fastener body 302. Optionally, the spring assembly 320 may be fabricated as a unitary device and coupled to fastener body 302 using a welding or brazing procedure, for example. In the exemplary embodiment, the fastening device 300 includes a plurality of spring arms 324.

As shown in FIGS. 8 and 9, the flange member 322 includes at least one tab 323 extending radially outwardly from the flange member 322. Moreover, the tunable spring arm 324 includes a first end 325 and a distal second end 327. The first end is formed unitarily with the flange member tab 323, and thus is formed unitarily with the fastener body 302. The second end 327 is disposed at an angle θ from the flange member tab 323. In the exemplary embodiment, the angle θ is less than ninety degrees. The tunable spring arm first and second ends 325 and 327 are each spaced an equal distance radially outwardly from the fastener body 302. For example, as shown in FIG. 8, the first end 325 is spaced a distance D from the flange member 322 and the second end is also spaced the distance D from the flange member 322. As a result, a width 329 of spring arm 324 is constant in the radial direction extending around fastener body 302.

The tunable spring arm 324 also has a length 334. The length of spring arm 324 is based on the overall circumference of the spring assembly 320. For example, in the exemplary embodiment, the quantity of spring arms 324 is based on the equation S=rΦ, where r is the radius of fastening device, S is the length of the combination of the tunable spring arm 324 and a respective tab 323, and Φ is the linear angle between each combination of the tunable spring arm 324 and a respective tab 323. For example, as shown in FIG. 8, Φ is approximately 120 degrees. Thus the fastening device 300 shown in FIG. 8 includes three tunable spring arms 324 and three tabs 323. As another example, shown in FIG. 9, Φ is approximately 90 degrees. Thus the fastening device 300 shown in FIG. 9 illustrates four tunable spring arms and four tabs 323. It should be realized that Φ may be decreased to increase the quantity of tunable spring arms 324 or increased to decrease the quantity of tunable spring arms 324 based on the desired pressure to be exerted on the fastening device 300. In the exemplary embodiment, the spring arm 324 is disposed at an angle θ from the flange member 322. In the exemplary embodiment, the angle θ is less than 90 degrees and greater than 45 degrees.

To fabricate fastening device 300, fastening device 300 is stamped from a single plate to form fastener body 302 and spring assembly 320. Optionally, spring assembly 320 is coupled to fastener body 302 using a welding or brazing procedure, for example. The spring assembly 320 is stamped to form the flange member 322 and the plurality of spring arms 324. In the exemplary embodiment, each spring arm 324 is identical to each other respective spring arm 324.

As discussed above, the spring arms 324 distribute the load applied by the bolt 46 onto a work-piece to allow the work-piece to move a designed amount to compensate for noise, vibration, or harshness purposes. As such, the spring arms 324 are tunable to fit any particular application and load curve desired. One such method of tuning the spring arms 324 is to fabricate the fastening device 300, including spring arms 324, from a selected material as discussed above. Another exemplary method of tuning the fastening device 100 is to alter the quantity, size, or thickness of the spring arms 324. For example, to increase the stiffness and thus the load bearing capabilities of the spring arms 324, it may be desirable to increase the surface area of the spring arms 324 contacting the work-piece 12. It may also be desirable to increase the quantity of spring arms 324 as discussed above. Moreover, the length and/or width of the spring arms 324 may be adjusted to allow decreased or increased torque to be transmitted from the bolt 46 to the second work-piece 12, i.e. to increase the pressure coupling the first and second work-pieces 10 and 12 together.

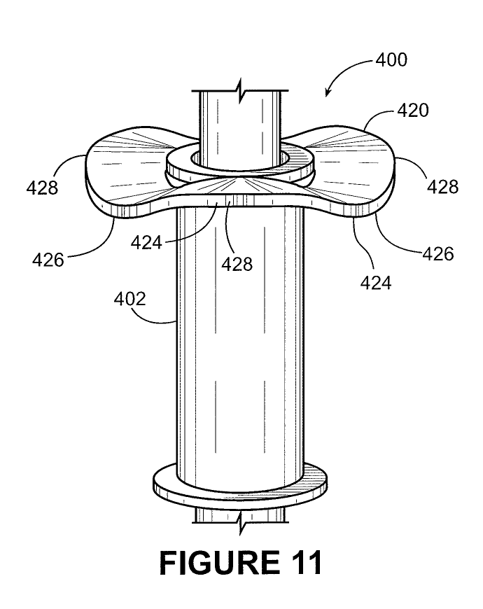

FIG. 10 is a side view of another exemplary fastening device 400 that may be used to couple work-piece 10 to work-piece 12. FIG. 11 is a perspective view of fastening device 400. In the exemplary embodiment, fastening device 400 includes a spring assembly 420 that is coupled to a fastener body 402. In the exemplary embodiment, the spring assembly 420 is coupled to an end 421 of fastener body 402 and extends radially around the fastener body 402. As such, spring assembly 420 is substantially contiguous. As shown in FIG. 10, spring assembly 420 has a substantially sinusoidal cross-sectional profile and includes at least two pairs 424 of tunable springs. Each pair 424 of tunable springs includes a concave spring 426 and an adjacent convex spring 428. For example, as shown in FIG. 11, fastening device 400 includes three concave springs 426 alternating between three convex springs 428 to form the sinusoidal profile discussed above.

One such method of tuning the spring assembly 420 is to fabricate the fastening device 400, including springs 424, from a selected material as discussed above. Another exemplary method of tuning the fastening device 400 is to alter the quantity, size, or thickness of the springs 424. For example, to increase the stiffness and thus the load bearing capabilities of the springs 424, it may be desirable to increase the surface area of the springs 424 contacting the work-piece 12, e.g. to increase the quantity of springs 424. Moreover, the length and/or width of the springs 424 may be adjusted to allow decreased or increased torque to be transmitted from the bolt 46 to the second work-piece 12, i.e. to increase the pressure coupling the first and second work-pieces 10 and 12 together.

In the exemplary embodiment, the quantity of springs 424 is based on the equation S=rΦ, where r is the radius of fastening device, S is the length of the spring 424, and Φ is the angle between respective springs 424. For example, as shown in FIG. 11, Φ is approximately 120 degrees. Thus the fastening device 400 shown in FIG. 11 illustrates three pairs 424 of tunable springs. It should be realized that Φ may be decreased to increase the quantity of tunable springs 424 or increased to decrease the quantity of pairs 424 of tunable springs based on the desired pressure to be exerted on the fastening device 400. For example, assuming Φ is set to 60 degrees, the quantity of pairs of springs 424 is increased to six pairs springs, e.g. six concave springs 426 and six convex springs 428, etc.

To fabricate fastening device 400, fastening device 400 is stamped from a single plate to form fastener body 402 and spring assembly 420. Optionally, spring assembly 420 is coupled to fastener body 402 using a welding or brazing procedure, for example. The spring assembly 420 is stamped to form the flange member 422 and the plurality of springs 424. In the exemplary embodiment, each spring 424 is identical to each other respective spring 424. However, the springs 424 are arranged in an alternating convex and concave arrangement as discussed above.

Described herein is a fastening device that includes a metallic spring that is formed in the top of a drawn tube as a means of preventing vibration from transferring from a base to a work-piece. A bolt passes through a center of the tube. When the bolt is tightened, the bolt transfers load into the spring and the spring begins to compress. The metal tube limits the compressive force created by the bolt. The spring transfers the load to the top of the first work-piece. A rubber gasket is installed on the bottom of the first work-piece to transfer the load from the first work-piece to second work-piece. When the second work-piece vibrates the compressed gasket and metal spring absorb kinetic energy and reduce the amount of vibration force that is transferred to the first work-piece.

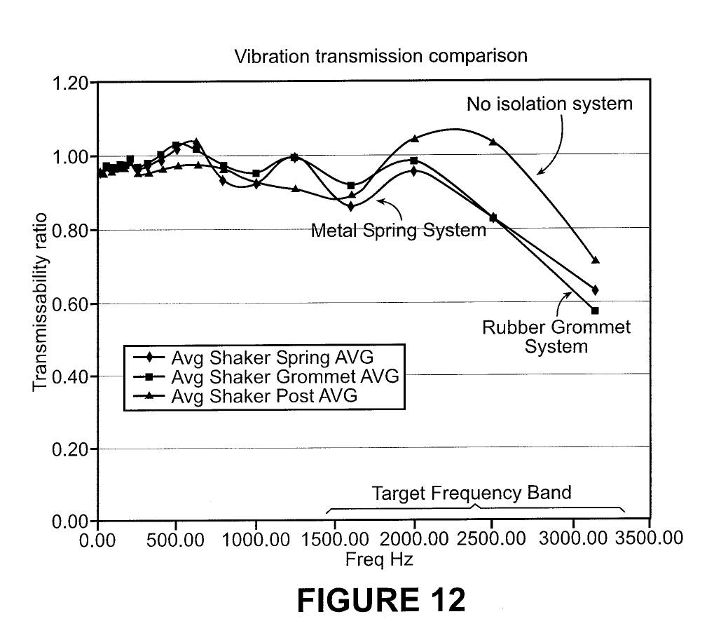

FIG. 12 is a graphical illustration of a vibration transmission comparison between a known isolated system that includes a grommet and the exemplary fastening devices described herein. As shown in FIG. 12, the isolation effect of the known rubber grommet system is compared to the isolation effect of the exemplary fastening devices described herein. The metallic springs described herein are measured with the transmissibility ratio of the work-piece to the base. As shown in FIG. 12, a lower ratio value equates to more isolation benefit

The fastening device described herein utilizes fewer components than known fastening devices by eliminating the known grommet system. Moreover, the fastening device is more durable that the rubber grommet. There is potentially less tolerance stack-up in the fastening device since there is one less component, i.e. the grommet has been eliminated. Additionally, the isolation effect of the fastening device described herein is greater than the known rubber grommet system, i.e. the transmissibility ratio of the first work-piece to the second work-piece is reduced. Lower ratio value equates to more isolation benefit.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

The present invention addresses these drawbacks and other drawbacks by providing a fastening device that replaces the functionality of the grommet yet eliminates the need for the grommet. In short, the fastening device described herein provides a new sleeve for use in an isolated system. FIGS. 1-11 describe and illustrate various aspects of the exemplary fastening devices according to the present invention. FIG. 12 is a graphical illustration of the present inventions compared to the known rubber grommet assembly.

Various features of the invention are set forth in the following claims.

What is claimed is:

1. A fastening device for coupling a first work-piece to a second work-piece, said fastening device comprising:
a fastener body configured to be received in the first work-piece; and
a spring assembly coupled to the fastener body, said spring assembly comprising:
a flange member; and
a plurality of tunable springs extending radially outward from the flange member, the tunable springs are each configured to deform when a predetermined pressure is applied to the flange member, wherein the predetermined pressure is sufficient to couple the first work-piece to the second work-piece.

2. A fastening device in accordance with claim 1, wherein said spring assembly is formed unitarily with the fastener body.

3. A fastening device in accordance with claim 1, wherein said plurality of tunable springs are spaced equidistantly around a periphery of said flange member.

4. A fastening device in accordance with claim 3, wherein said plurality of tunable springs are formed unitarily with said flange member.

5. A fastening device in accordance with claim 3, wherein said flange member comprises a plurality of slots formed therein, each of said plurality of tunable springs sized to be received within a respective slot.

6. A fastening device in accordance with claim 1, wherein each of said tunable springs includes a spring portion formed unitarily with said flange member and a contact portion formed unitarily with said spring portion, said spring portion being disposed at an angle from said fastener body, said contact portion being disposed approximately parallel to said flange member.

7. A fastening device in accordance with claim 1, wherein said plurality of tunable springs comprises a plurality of convex springs and a plurality of concave springs.

8. A fastening device in accordance with claim 7, wherein each of said convex springs is disposed between a pair of concave springs such that said spring assembly has a sinusoidal cross-sectional profile.

9. A fastening device in accordance with claim 1, wherein each of said tunable springs comprises at least one tab extending radially outwardly from said flange member, each of said tunable springs comprises a first end and a distal second end, said first end is formed unitarily with said flange member tab, said second end is disposed at an acute angle with respect to said flange member tab.

10. A fastening device in accordance with claim 9, wherein said spring first and second ends are each spaced an equal distance radially outwardly from said fastener body.

11. A fastening device in accordance with claim 1, wherein said tunable springs constitute metallic tunable spring arms.

12. A fastening device in accordance with claim 1, wherein said tunable springs constitute tunable cantilever springs formed unitarily with said flange member.

13. A method for fabricating a fastening device for coupling a first work-piece to a second work-piece, the method comprising:
determining a coupling force to be utilized to couple the first work-piece to the second work-piece;
fabricating a fastening device including a fastener body and a spring assembly coupled to the fastener body; and
forming the spring assembly with a plurality of tunable springs that extend radially outward from the fastener body, the tunable springs being formed to deform when a predetermined pressure is applied to the fastening device, the predetermined pressure relating to the coupling force.

14. A method in accordance with claim 13, further comprising stamping and forming the spring assembly to include a flange member with a plurality of tunable spring arms extending radially outward from the flange member.

15. A method in accordance with claim 13, wherein the forming includes dimensioning at least one of a width, a length, and a thickness of the tunable springs such that the tunable springs deform when the predetermined pressure is applied.

16. A method in accordance with claim 13, further comprising spacing the plurality of tunable springs equidistantly around a periphery of the fastener body.

17. A method in accordance with claim 13, further comprising stamping the spring assembly to simultaneously form a plurality of slots and a spring arm disposed within each respective slot.

18. A method in accordance with claim 13, further comprising fabricating the spring assembly to include a plurality of convex springs and a plurality of concave springs.

19. A method in accordance with claim 18 further comprising fabricating the spring assembly such that the convex springs are disposed between a pair of concave springs and such that the spring assembly has a sinusoidal cross-sectional profile.

20. A method in accordance with claim 13 wherein the plurality of tunable springs each comprise a tab and a spring portion, said method further comprising fabricating the spring assembly such that the tabs extend radially outwardly from the fastener body and such that a spring portion is formed unitarily with each respective tab.

21. A method in accordance with claim 20 further comprising orienting the spring portions to extend axially around the fastener body.

22. A method in accordance with claim 21 further comprising fabricating the spring assembly such that each spring portion includes a first end and a distal second end, the first end being formed unitarily with the tab, the second end being disposed at an acute angle with respect to the fastener body.

23. A method in accordance with claim 13 wherein the spring assembly includes a plurality of tunable cantilever springs disposed at an angle relative to the fastener body, said method further comprises adjusting the angle of the cantilever springs based on the determined pressure.
